(19) United States
(12) Patent Application Publication
(10) Pub. No.: US 2015/0178968 A1
(43) Pub. Date: Jun. 25, 2015

(54) IMAGING MODULE IN MOBILE DEVICE

(71) Applicant: Entetrainer Oy, Espoo (FI)

(72) Inventors: Timo Salmi, Vantaa (FI); Tomi Salmi, Vantaa (FI); Anssi Luomaranta, Espoo (FI); Antti Väänänen, Espoo (FI); Lauri Ilvas, Espoo (FI); Lasse Riitesuo, Jyväskylä (FI); Hanna Salmi, Vantaa (FI)

(73) Assignee: Entetrainer Oy, Espoo (FI)

(21) Appl. No.: 14/414,659

(22) PCT Filed: Jul. 11, 2013
(86) PCT No.: PCT/FI2013/050747

§ 371 Date: Jan. 13, 2015

Related U.S. Application Data
(60) Provisional application No. 61/671,269, filed on Jul. 13, 2012.

(51) Int. Cl. G06T 11/60

(52) U.S. Cl. CPC G06T 11/60

(57) ABSTRACT

The invention relates to an imaging module in a mobile device. The imaging module is configured to automatically overlay a plurality of predetermined graphical objects on a digital image taken by an integrated camera of the mo- bile device. At least part of the overlay objects present an approximately real-time content obtained from application server, thereby creating a composite image.

### BACKGROUND OF THE INVENTION

The invention relates to photographing and editing in a mobile device, such a mobile phone.

A mobile phone as one of communication means has more diversified functions along with the continuous development of communication technology. A camera phone is a mobile phone which is able to capture still photographs (and usually video). Since early in the 21st century the majority of mobile phones in use are camera phones. Smartphones that are camera phones may run mobile applications to add capabilities such as geotagging and image stitching. Geotagging is the process of adding geographical identification metadata to various media such as a photograph. Auto-geotagging can show where a picture is taken, promoting interactions and allowing a photo to be mapped with others for comparison. Another approach is using camera images to recognize objects. The camera phone solution allows instant sharing of pictures using the communication capabilities of the phone. Instagram is a free photo sharing program that allows users to take a photo, apply a digital filter to it, and then share it on a variety of social networking services, including Instagram's own.

There is a desire for new techniques and methods for mobile digital imaging, editing and photo sharing.

### BRIEF DESCRIPTION OF EMBODIMENTS

An object of the invention is to provide for new techniques and methods for mobile digital imaging, editing and/or photo sharing. This object is achieved by an imaging module, a mobile device, a computer program, and a network server according to the independent claims. Preferred embodiments of the invention are disclosed in the dependent claims.

An aspect of the invention provides a mobile device with an imaging module which automatically overlays a plurality of predetermined graphical objects on a digital image taken by an integrated camera of the mobile device, at least part of predetermined overlay objects presenting an approximately real-time content obtained from at least one network server.

In an embodiment, the predetermined graphical objects may provide a picture frame or a skin for the digital image.

In an embodiment, the real-time content may include any information related to a moment at which the digital image is taken.

In an embodiment, art of the predetermined overlay objects may present data content based on a user profile.

An aspect of the invention is an application server which may maintain up-to-date (real-time) information about on-going events, such as sport events, more particularly ice hockey games or football games.

In an embodiment, the server may retrieve or update the maintained information from external servers, databases or score services.

In an embodiment, the information retrieval or update may be performed at regular intervals, such every x seconds, wherein X may range from less than 1 second up to hundreds of seconds.

In an embodiment, the information retrieval or update may be performed at irregular intervals.

In an embodiment, the information retrieval or update may be performed as push service from external servers, databases or score services.

In an embodiment, the imaging module may take into account update intervals of the real-time data in the application server, and the imaging module may delay inserting the real-time data into the predetermined graphical overlay objects until update covering the time of taking the image is available.

In an embodiment, the imaging module may delay retrieving and/or the inserting the real-time data for an interval corresponding to an update interval used by an application server, such as x seconds, wherein X may range from less than 1 second up to hundreds of seconds.

### BRIEF DESCRIPTION OF THE DRAWINGS

In the following the invention will be described in greater detail by means of exemplary embodiments with reference to the attached drawings, in which

FIG. 1 illustrates a mobile phone operated in a camera mode;

FIG. 2 illustrates an example of a digital composite image provided with overlay graphical objects without any content;

FIG. 3 illustrates an example of a composite image (a final photo) with the desired game data content;

FIG. 4 shows a picture of a composite image on a phone's camera screen and a picture of the final photograph;

FIG. 5 illustrates an example of an architecture and operation of the system;

FIG. 6 illustrates an example of a user interface (e.g. browser page) for registration, login, use and log out;

FIG. 7 illustrates a viewfinder view displayed on a screen of a mobile phone with graphical overlay objects; and

FIG. 8 is a schematic block diagram of an exemplary system in which the invention can be used.

### DETAILED DESCRIPTION

In sport events, concerts, and like events, spectators often take digital images or digital photographs from the same event, and especially self-portraits using their mobile phones provided with a digital camera. Similarly, people may take digital images or digital photographs at home, in a sport bar, etc. when they are watching a television broadcast or a video webcast of such event. These photographs are related to the specific event, and more particularly to special moments or experiences during the event. For example, a fan may take a photo of himself celebrating a goal scored by his favourite football club. However, it may be very difficult to afterwards recall why, where and when the photo was taken, or associate the photo with a specific experience. Inherent metadata of the digital image may contain a time stamp as well as a geographic location but otherwise photo tells a little of the specific moment and experience. Many people are also willing to share the moment and experience with their friends or other fans, e.g. using a service like Instagram or Facebook, but the photo as such may be even less informative for the others who do not know the context. Users may of course publish their photos on Facebook, home pages, blogs with subsequently provided explanations, but this is often cumbersome and far from real-time sharing of the experience.

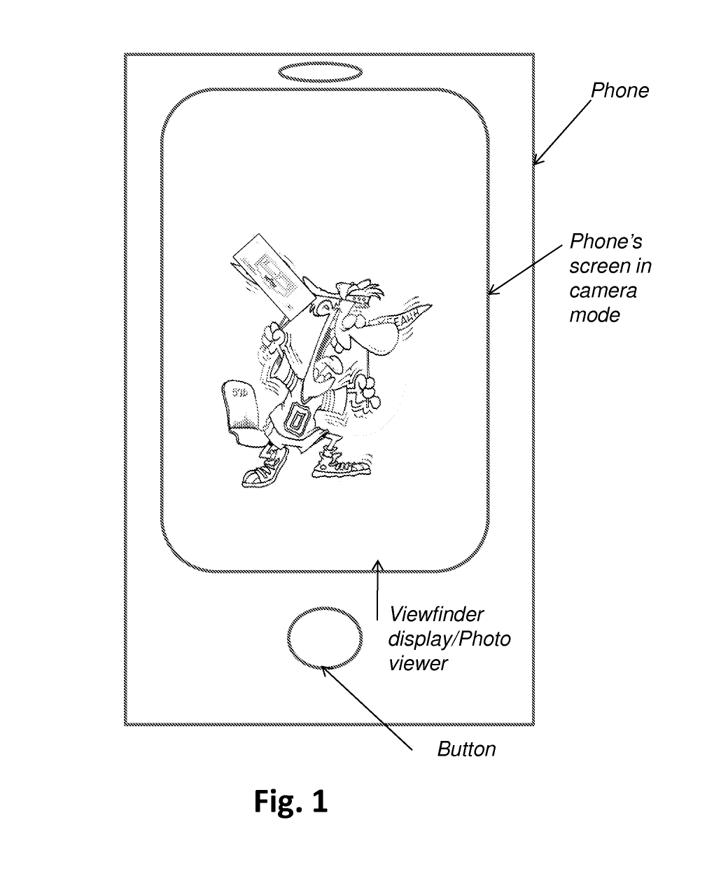

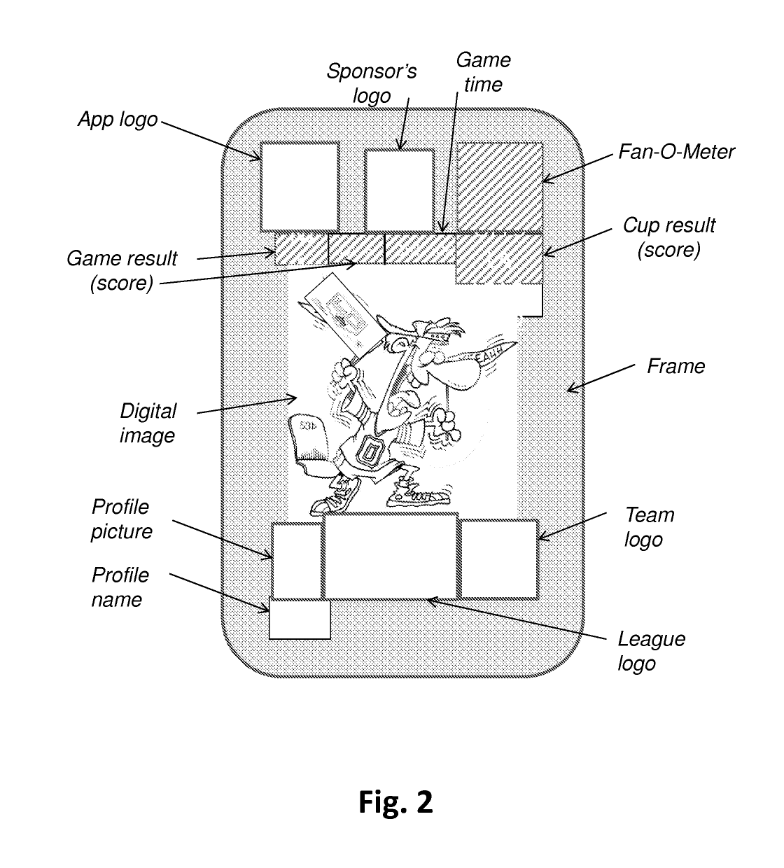

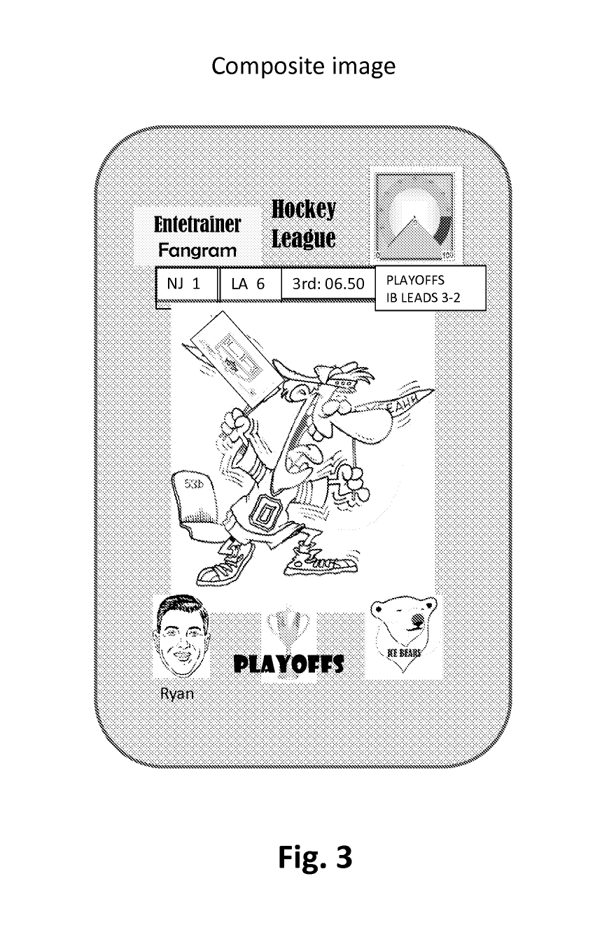

An aspect of the invention provides a mobile phone with an imaging module which automatically overlays a plurality of predetermined graphical objects on a digital image taken by an integrated camera of the mobile phone, at least part of predetermined overlay objects presenting a real-time content obtained from at least one network server. The predetermined graphical objects may provide a picture frame or a skin around the digital image. FIG. 1 illustrates a mobile phone operated in a camera mode. FIG. 2 illustrates an example of a digital image provided with predetermined overlay graphical objects or their locations without any content. The overlay objects are shown as rectangular objects for illustration purposes only. FIG. 3 illustrates an example of a composite image (a final photo) after the predetermined graphical overlay objects with the desired game data or other desired content have been added on the digital image.

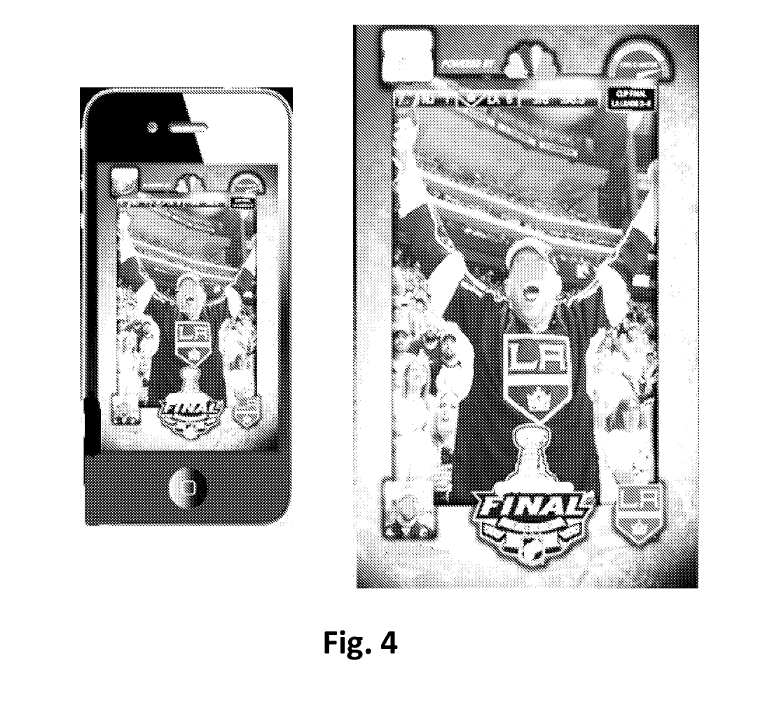

FIG. 4 shows a picture of a composite image on a phone's camera screen and a picture of the final photograph.

It should be appreciated that the term ‘real-time’ as used herein is intended to mean almost/approximately real-time with a certain tolerance, i.e. within a time window required for updating the data. For example, the tolerance or time window may be x seconds, wherein X may range from less than 1 second up to hundreds of seconds.

The real-time content may include any information related to the moment at which the digital image is taken. For example, the real-time content may include one or more of real-time game data, score, a picture of a player who scored venue of the event, number of spectators, player statistics, game statistics, time of day. In the example of FIG. 2 the objects with a real-time or varying content are provided with a diagonal line filling.

Part of the predetermined overlay objects may also present data content based a user profile, such as user's name, user's name, a team logo, a league logo, a cup logo, a picture of a favourite player, etc. In the example of

FIG. 2 the objects with a real-time or varying content are provided with no filling.

An aspect of the invention is an application server which may maintain up-to-date (real-time) information about on-going events, such as sport events, more particularly ice hockey games or football games. The server may retrieve or update the maintained information from external servers, databases or score services. In an embodiment the information retrieval or update may be performed at regular intervals, such every x seconds, wherein X may range from less than 1 second up to hundreds of seconds. In an embodiment the information retrieval or update may be performed at irregular intervals. In an embodiment the information retrieval or update may be performed as push service from external servers, databases or score services.

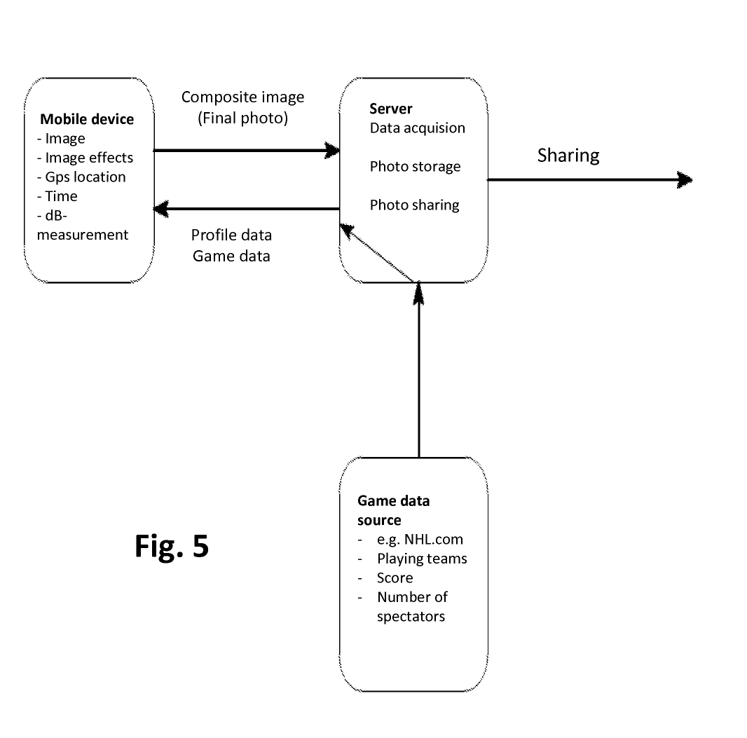

An example of an architecture and operation of the system is illustrated in FIG. 5.

In an embodiment the application server may comprise an existing (e.g. official) server, database or score service (e.g. www.nhl.com) which may maintain up-to-date (real-time) information about on-going events, such as games in a league or cup, e.g. NHL league, NBA, Football Premium league, FIFA, Formula 1.

According to an aspect of the invention, the user may register and login to a photo editing and sharing service at the application server, before he/she is able to use the real-time data features. In some embodiments of the invention, the imaging module may enable a non-real time creation of a composite image, although there is no connection to the application server.

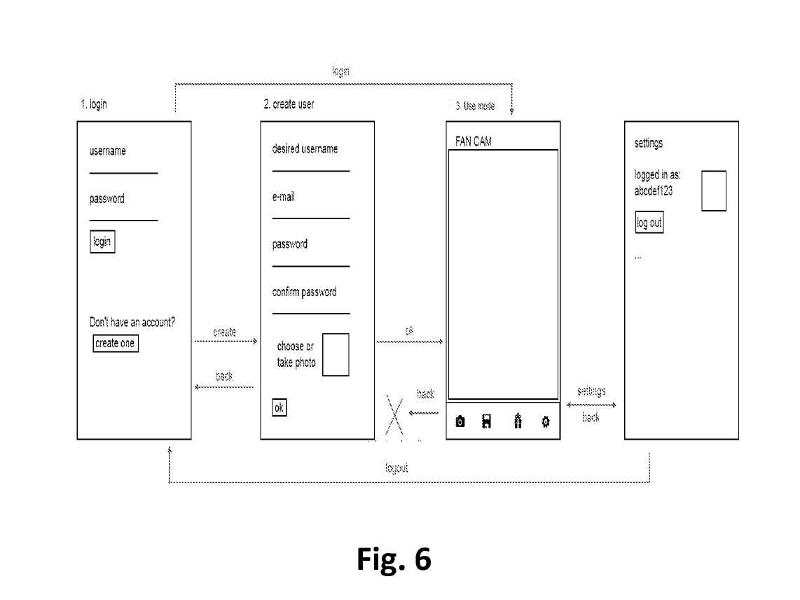

An example of a user interface for registration, login, use and log out is illustrated in FIG. 6. The user may create an account on the server, e.g. the user may give a desired username, the email address, a desired password, and upload his portrait photo, etc. provide any desired profile data. For example, the profile may also contain a favourite team logo, a league logo, a cup logo, a picture of a favourite player, etc., which information may be used as a content for some of the predetermined overlay objects. The profile may also include a configuration of overlay objects which the user desires have added to a digital image. Some or all of this data may be maintained both on the server and in the mobile device.

According to an aspect of the invention, the imaging module in the mobile phone may retrieve the maintained real-time data for the overlay graphical objects from the application server based on the time of taking the digital image by the camera of the mobile phone.

In an embodiment, time metadata added by a camera into an image file may be utilized by the imaging module to retrieve respective real-time data and/or add the retrieved data into the predetermined graphical overlay objects.

In an embodiment, the imaging module may take into account the update intervals of the real-time data in the application server, and the imaging module may delay inserting the real-time data into the predetermined graphical overlay objects until update covering the time of taking the image is available. For example, the imaging module may delay retrieving and/or the inserting the real-time data for an interval corresponding to an update interval used by an application server, such as x seconds, wherein X may range from less than 1 second up to hundreds of seconds.

As another example embodiment, the imaging module may compare a time information of the image to the time information of the real-time data available, and it may use the available real-time data only, if the time information of the available real-time data is not earlier that the time information of the image. The checking of the correctness of the real-time data may vary depending on the data type. The correctness of the real-time data may be of a particular importance in the case of score data. The application server may contain almost real-time data on each sport which is followed. Based on a venue of the game (e.g. a football or ice hockey stadium) and the time the application server may provide an imaging module in a mobile phone with game data, such as teams playing each other in the game, score of the game, number of spectators, phase of the league or cup (a regular, season, play-offs, finals), a rank of a team in the league or cup, etc.

A user may take a digital image, i.e. a digital photograph, with a camera of a mobile phone as illustrated in the example of FIG. 1. In an embodiment of the invention the user may start the imaging module for editing the digital image. The imaging module may send to the application server an information request with a geographical location (which may be obtained from a GPS module in a mobile phone), a venue of an event ID, a favourite team ID, a user ID, and/or a time of the digital image, or any combination thereof.

In an embodiment of the invention, the application server may automatically send or push game data to the imaging module at predetermined intervals, e.g. after each update in n the application server, or each time the update in the application server causes a change in the relevant data.

The application server may determine which game data is needed based on the data received with the request, and/or based on data in a user profile the user may have created on the application, e.g. at a registration phase. For example, if a user with a specific user ID is a fan of a specific ice hockey team according to the user profile, the application server may send a reply with game data on the on-going game of the specific team, even if the application server does not know whether the user is present at the venue of the game or not. Thus, the imaging module may automatically receive the desired game data to any location, which may be desired when the user is watching the game on television at home or on a screen in a sport bar, for example.

Upon having the desired game data or other desired content available in the mobile phone, the imaging module may add the predetermined graphical overlay objects with the content on the digital image, thereby creating a composite image. The composite image may be stored locally in a memory of the mobile phone and/or transferred to the application to be stored therein and/or to be shared by a suitable way. A sharing of the composite image from the mobile phone or from the application server to social media may be carried out with any photo sharing method or service or available.

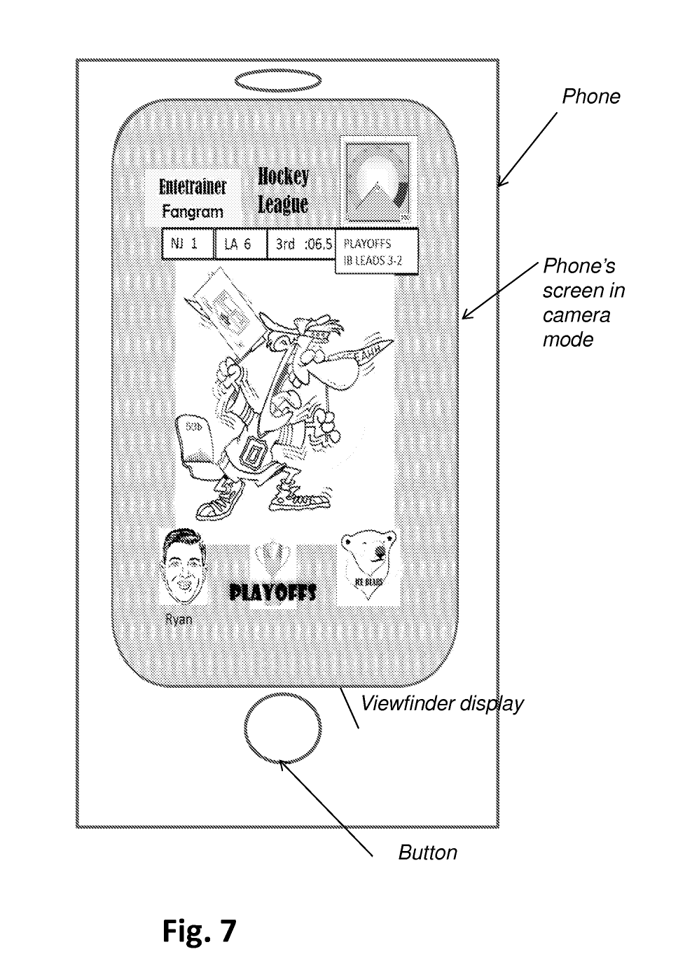

In an embodiment of the invention, the imaging module may add the predetermined graphical objects with desired content already to a viewfinder view displayed on a screen of a mobile phone, as illustrated in the example of FIG. 7. The user may now see a resulting composite image already at the time of photographing.

In an embodiment, taking of a digital image by the camera may be triggered automatically by the imaging module in response to a predetermined content change, such as a favourite team scoring (the respective score value increases), the value of a content reaching a predetermined threshold, e.g. a noise level measured at the venue exceeding a preset threshold, a statistical value reaching a record limit, etc.

In an embodiment, the user interface and/or the output circuitry (e.g. display, earphone and/or loudspeaker) of the mobile device may be triggered automatically by the imaging module to provide an audio and/or visual notification/indication in response to a predetermined content change (or in response to a notification or a command from the application server), such as a favourite team scoring (the respective score value increases), the value of a content reaching a predetermined threshold, e.g. a statistical value reaching a record limit, etc. The content to be monitored and a predetermined threshold may be set by a user and/or set automatically based on the user profile.

In an embodiment, the application server may automatically send or push game data or a notification or a command to the imaging module in response to a predetermined content change, such as a favourite team scoring (the respective score value increases), the value of a content reaching a pre-determined threshold, e.g. a statistical value reaching a record limit, etc. The game data or a notification or a command may cause the imaging module to trigger the user interface and/or the output circuitry (e.g. display, earphone and/or loudspeaker) of the mobile device to provide an audio and/or visual notification/indication for alerting the user of the predetermined content change. The content to be monitored and a predetermined threshold may be selected automatically based on the user profile.

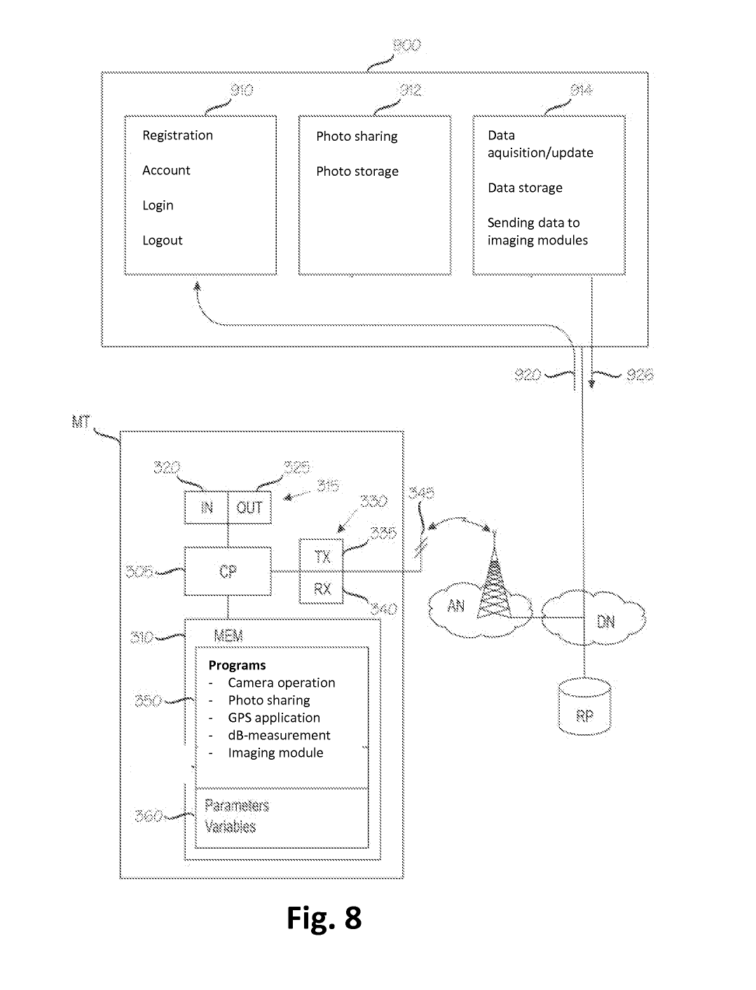

FIG. 8 is a schematic block diagram of a representative exemplary system in which the invention can be used, the system including a mobile terminal MT. The mobile terminal MT may comprise a central processing unit CP 305 and memory 310. In addition, the mobile terminal MT may comprise or utilize external input-output circuitry 315 which may constitute the multimode terminal's user interface and comprises an input circuitry 320 and an output circuitry 325. The input circuitry 320 may comprise the mobile terminal's microphone and user-input device, such as a keypad and/or touch screen. The output circuitry 325 may comprise the mobile terminal's display and earphone or loudspeaker (not shown separately). The mobile terminal MT may further comprise or utilize reception/transmission circuitry 330 which may comprise a transmission circuitry 335, reception circuitry 340 and antenna 345. In order to support installable program modules, the mobile terminal's memory MEM may comprise routines for downloading installable program modules and for storing the installable program modules in the memory MEM for execution by the central processing unit CP. FIG. 8 shows an arrangement in which the mobile terminal is configured to download installable program modules from a repository RP via a data network DN, a wireless access network AN, the antenna 345 and reception circuitry 340, although other arrangements are equally possible, such as downloading the installable program modules via a short-range connection, such as Bluetooth or Universal Serial Bus (USB, not shown separately). At this level of generalization, all previously-discussed elements of FIG. 8 can be conventional as used in the relevant art.

The mobile terminal's memory MEM may be provided with a program module 350 which implements the functions of the imaging module according to embodiments of the invention. The program module 350 may use the mobile terminal's memory MEM for storing a digital image, contents of the overlay object, user profile, various parameters and variables, or like, collectively denoted by reference numeral 360.

FIG. 8 illustrates also an exemplary embodiment of a server system 900 configured to provide functionality according to an embodiment of the invention. The server system 900 may be dimensioned such that it is capable of serving a large number of mobile terminal MT and their users. In order to support a large number of mobile terminals and users, the server system may ideally comprise a plurality of processors, a fast database system and load-sharing system (not shown separately). The server system 900 may comprise several logic sections. One of these, denoted by reference numeral 910, may perform and manage registration, account creation, login, logout, etc. user related procedures. The users may register via their mobile terminals MT and/or via internet browsers (not shown separately). A user's registration process may establish a subscribership of a service well as an identity and password for member. The identity and password may be required for further log-in procedures.

A photo sharing section 912 may perform storing of user's photos and sharing of user's photos in a social media, such as Facebook. The photo sharing may be carried out with any available service or technique. A desired manner of photo sharing, and rules and settings thereof, may be configured in the user profile.

A data acquisition/update section 914 may store and maintain up-to-date (real-time) information, and acquire or update the maintained information from external servers, databases or score services. The section 914 may further automatically or on demand send or push game data to the imaging modules.

The techniques described herein may be implemented by various means. For example, these techniques may be implemented in hardware (one or more devices), firmware (one or more devices), software (one or more modules), or combinations thereof. For a firmware or software, implementation can be through modules (e.g., procedures, functions, and so on) that perform the functions described herein. The software codes may be stored in any suitable, processor/computer-readable data storage medium(s) or memory unit(s) and executed by one or more processors. The data storage medium or the memory unit may be implemented within the processor or external to the processor, in which case it can be communicatively coupled to the processor via various means as is known in the art. Additionally, components of systems described herein may be rearranged and/or complimented by additional components in order to facilitate achieving the various aspects, goals, advantages, etc., described with regard thereto, and are not limited to the precise configurations set forth in a given figure, as will be appreciated by one skilled in the art.

Exemplary embodiments described above can be combined into any combination embodiments.

An aspect of the invention is further a computer program comprising program code for performing a method which implements any embodiment of the invention, or any combination of embodiments, when the program is run on one or more computer or processor.

An aspect of the invention is further a computer program product comprising program code means stored on a computer readable medium for performing a method which implements any embodiment of the invention, or any combination of embodiments, when the program is run on one or more computer or processor.

An aspect of the invention is further a mobile terminal comprising a wireless communication unit configured to attach to a wireless network and a software program product, wherein execution of the software program product in the mobile terminal causes the mobile terminal to carry out acts which implement any embodiment of the invention, or any combination of embodiments.

An aspect of the invention is further a server system operatively coupled to a wireless network which supports bidirectional communication between the server and a mobile terminal, and comprising a software program product, wherein execution of the software program product in the server system causes the mobile terminal to carry out acts which implement any embodiment of the invention, or any combination of embodiments.

The description and the related figures are only intended to illustrate the principles of the present invention by means of examples. Various alternative embodiments, variations and changes are obvious to a person skilled in the art on the basis of this description. The present invention is not intended to be limited to the examples described herein.

1-24. (canceled)

25. An imaging module in a mobile device, the imaging module being configured to automatically overlay a plurality of predetermined graphical objects on a digital image taken by an integrated camera of the mobile device, at least part of predetermined overlay objects presenting an approximately real-time content obtained from at least one network server, thereby creating a composite image.

26. An imaging module as claimed in claim 25, wherein the imaging module is configured to add the predetermined graphical objects with desired content already to a viewfinder view displayed on a camera screen of a mobile device such that the resulting composite image is displayed to a user already at the time of photographing.

27. An imaging module as claimed in claim 25, wherein the imaging module is configured to automatically trigger the integrated camera to take the digital image in response to a predetermined content change.

28. An imaging module as claimed in claim 25, wherein the imaging module is configured to automatically trigger a user interface and/or earphone and/or loudspeaker of the mobile device to provide an audio and/or visual notification/indication in response to a predetermined content change or in response to a notification or a command from the application server.

29. An imaging module as claimed in claim 25, wherein the predetermined graphical objects comprise a picture frame or a skin for the digital image.

30. An imaging module as claimed in claim 25, wherein the real-time content comprises any information related to a moment at which the digital image is taken.

31. An imaging module as claimed in claim 25, wherein part of the predetermined overlay objects are configured to present data content based on a user profile.

32. An imaging module as claimed in claim 25, wherein the imaging module is configured to retrieve respective real-time data and/or add the retrieved data into the predetermined graphical overlay objects based on time metadata added by the integrated camera into an image file.

33. An imaging module as claimed in claim 25, wherein the imaging module is configured retrieve the maintained real-time data for the overlay graphical objects from the application server based on the time of taking the digital image by the camera of the mobile phone.

34. An imaging module as claimed in claim 25, wherein the imaging module is configured to receive real-time data that are automatically sent or pushed by the at least one network server at predetermined intervals, after each update in at least one network server, and/or each time the update in the at least one network server causes any content change or a predetermined content change in the relevant data.

35. An imaging module as claimed in claim 25, wherein the imaging module is configured to compare a time information of the image to time information of the real-time data available, and to use the available real-time data only, if the time information of the available real-time data is not earlier that time information of the digital image.

36. An imaging module as claimed in claim 25, wherein the imaging module is arranged to take into account update intervals of the approximately real-time data at said at least one network server, and the imaging module may delay inserting the real-time data into the predetermined graphical overlay objects until update covering the time of taking the image is available at the at least one network server.

37. An imaging module as claimed in claim 25, wherein the imaging module is arranged to delay retrieving and/or the inserting the real-time data for an interval corresponding to an update interval used by an application server, such as x seconds, wherein X may range from less than 1 second up to hundreds of seconds.

38. An imaging module as claimed in claim 25, wherein the imaging module is arranged to store the composite image locally in a memory of the mobile phone and/or transferred to the at least one network server to be stored therein and/or to be shared by a suitable way.

39. An imaging module as claimed in claim 25, wherein the imaging module includes a computer program comprising program code stored on a computer readable medium in the mobile device for implementing the functionality of the imaging module, when the program is run on one or more computer or processor in the mobile device.

40. A computer readable device storing an executable code that, when the executable code is run on one or more computer or processor in a mobile device including an imaging module, configures the imaging module to automatically overlay a plurality of predetermined graphical objects on a digital image taken by an integrated camera of the mobile device, at least part of predetermined overlay objects presenting an approximately real-time content obtained from at least one network server, thereby creating a composite image.

41. A network server, the network server being configured to bidirectionally communicate with a mobile device provided with an imaging module configured to automatically overlay a plurality of predetermined graphical objects on a digital image taken by an integrated camera of the mobile device, at least part of predetermined overlay objects presenting an approximately real-time content obtained from at least one network server, thereby creating a composite image, and the network server being further configured to maintain approximately real-time content and to automatically sent or push approximately real-time content to the imaging module in the mobile device at predetermined intervals, after each update in the network server, and/or each time an update in the at least one network server causes any content change or a predetermined content change.

42. A network server as claimed in claim 41, wherein the network server is configured to retrieve or update the maintained information from external servers, databases or score services at regular intervals, and/or at irregular intervals, and/or as a push service from external servers, databases or score services.

43. A network server as claimed in claim 41, wherein the network server is configured to determine the approximately real-time content to be sent or pushed to the imaging module in the mobile device based on data received with a request from the imaging module, and/or based on data in a user profile maintained in the network server.

44. A network server as claimed in claim 41, wherein the network server is configured store a composite image created by and received from the imaging module, and/or to share with predetermined users a composite image created by and received from the imaging module.
